(19) United States
(12) Patent Application Publication
(10) Pub. No.: US 2003/0186705 A1
(43) Pub. Date: Oct. 2, 2003

(54) Hybrid channel allocation in a cellular network

(75) Inventors: Shlomo Lahav, Ramat Gan (IL); Asaf Shapira, Tel Aviv (IL); Shai Gutner, Tel Aviv (IL); Tami Boudoukh, Givataim (IL); Gil Shafran, Jerusalem (IL); Noam Taragan, Ramat Hasharon (IL)

Correspondence Address: Ladas & Parry, 26 West 61st Street, New York, NY, 10023, US

(73) Assignee: SCHEMA LTD.

(21) Appl. No.: 10/404,766

(22) Filed: Apr. 1, 2003

Related U.S. Application Data
(60) Provisional application No. 60/369,368, filed on Apr. 1, 2002.

(51) Int. Cl. H04Q 7/20

(52) U.S. Cl. 455/451; 455/450

(57) ABSTRACT

A method for channel allocation in a mobile communication network, based on an estimate of respective traffic density in each of a plurality of cells in the network, includes allocating to each of the plurality of the cells a first respective set of static channels for use in communicating with mobile units. The first respective set includes a respective number of the channels that is chosen based on the estimate of the traffic density so that a probability for all the static channels in the first respective set to be in use simultaneously for communicating with the mobile units is no less than a predetermined threshold probability. A second respective set of dynamic channels is allocated to each of the plurality of the cells, depending on the static channels allocated to the cells.

### CROSS-REFERENCE TO RELATED APPLICATION

This application claims the benefit of U.S. provisional patent application No. 60/369,368, filed Apr. 1, 2002, which is incorporated herein by reference.

### FIELD OF THE INVENTION

The present invention relates generally to planning and optimization of cellular communication networks, and specifically to optimizing the allocation of frequency channels among cells in such networks.

### BACKGROUND OF THE INVENTION

The region served by a cellular communication network is divided into a pattern of cells. Each cell has one or more antennas that communicate with mobile units (cellular telephones and/or data terminals) within its service area. The cell may be divided into sectors, each of which is typically served by a different antenna. In the context of the present patent application, the terms “cell” and “sector” are used interchangeably.

Each cell in a narrowband cellular network is assigned a fixed set of frequencies, also referred to as channels. Narrowband networks currently in use include primarily Time Division Multiple Access (TDMA) networks, such as Global System for Mobile (GSM) communication networks. In order to reduce interference between calls, the frequency channels in a narrowband cellular network are distributed among the different cells so that nearby cells use different channels. Because of the limited available spectrum, channel allocation generally involves tradeoffs between coverage of the service area and potential interference between different cells. If insufficient channels are available in a given cell, calls to and from mobile units in that cell may be blocked or dropped. On the other hand, if cells whose service areas overlap significantly use the same channels, mobile units in the overlap area will experience substantial interference.

Various tools have been developed to assist cellular network operators in optimizing frequency distribution among the cells in their service region. For example, U.S. Pat. No. 6,487,414, whose disclosure is incorporated herein by reference, describes a system and method for frequency planning using a mathematical representation of the interference between cells, known as an impact matrix. To calculate the impact matrix, signal levels at each location in the network service region are estimated based on weighted propagation analysis and empirical measurement data. The signal levels are used, together with other network data, in determining the matrix elements IMᵢⱼ, which represent the probability of interference between pairs of cells (i,j) transmitting on the same frequency. The impact matrix thus provides means for predicting the effect of different channel assignments on the signal quality and can be used in finding the optimal frequency allocation.

In most cases, because of the limited available frequency spectrum, it is impossible to find an allocation of frequencies that will entirely eliminate interference between cells while still providing each cell with a sufficient number of channels. As a general rule, each cell must have enough available channels so that no more than a small percentage of calls are blocked, even at times of peak demand. Different cells may experience their peak demand at different times. In common cellular networks, however, the allocation of channels is static, and it is not possible for a cell experiencing low demand to “loan” channels to another cell that needs them.

To address this problem, a new type of cellular network has recently been introduced, called a hybrid network, which uses dynamic channels in addition to the ordinary static channels. Each cell is allocated a set of static channels, similar to the fixed channels used in standard networks, along with a set of dynamic channels, which are used when the cell runs out of static channels. (The same frequency can serve as a static frequency in one cell and as a dynamic frequency in another cell.) Each cell uses its static channels before using any dynamic channel, and begins using its dynamic channels only when all of its static channels are already in use. Whenever a cell needs to use a dynamic channel, it chooses the cleanest frequency from its set of dynamic frequencies, i.e., the frequency on which it encounters the lowest level of interference. Thus, with judicious frequency allocation, hybrid networks can improve both the efficiency of frequency allocation and the quality of communications. Further details of hybrid networks are described by Katzela et al., in an article entitled “Channel Assignment Schemes for Cellular Mobile Telecommunication Systems: A Comprehensive Survey,” IEEE Personal Communications Magazine (1996), pages 10-31, which is incorporated herein by reference.

### SUMMARY OF THE INVENTION

The present invention provides methods for optimizing allocation of static and dynamic frequency channels in a hybrid cellular network. The inventors have found that efficient frequency use and good call quality are best achieved when each cell is allocated a sufficient number of static channels to serve its usual traffic load, without substantial excess static allocation above this level. Allocating too few static channels causes competition between cells for dynamic channels, resulting in poor exploitation of the available bandwidth and excessive interference among channels. On the other hand, when too many static channels are allocated, too few channels remain for dynamic allocation, and the added benefits of the hybrid network are lost.

Therefore, in embodiments of the present invention, the number of static channels allocated to each cell is chosen, based on an estimate of traffic in the cell, so that the probability over time that the cell will use all of its static channels is greater than a predefined threshold. In other words, the static channels are allocated so that for substantial periods of time (typically most of the time) none of the static channels is idle. This choice ensures that an adequate number of channels remain available for allocation as dynamic channels, but it also means that there will be substantial periods during which the static channel allocations are insufficient to handle all cell traffic. A sufficient number of dynamic channels is then allocated to each cell to cover the excess traffic above the static capacity of the cell, so that the probability of a blocked call does not exceed a predefined maximum (typically no more than a few percent). The dynamic channels are allocated in such a way that in any given cell, the available dynamic channels are those that are likeliest to be clean of interference.

There is therefore provided, in accordance with an embodiment of the present invention, a method for channel allocation in a mobile communication network, including:

providing an estimate of respective traffic density in each of a plurality of cells in the network;

allocating to each of the plurality of the cells a first respective set of static channels for use in communicating with mobile units, the first respective set including a respective number of the channels that is chosen based on the estimate of the traffic density so that a probability for all the static channels in the first respective set to be in use simultaneously for communicating with the mobile units is no less than a predetermined threshold probability; and

allocating to each of the plurality of the cells, depending on the static channels allocated to the cells, a second respective set of dynamic channels.

Typically, each of the cells uses the static channels to communicate with the mobile units as long as at least one of the static channels in the first respective set is available, and uses the dynamic channels otherwise. Allocating the first respective set may include allocating a given frequency to one of the cells for use as one of the static channels, while allocating the second respective set includes allocating the given frequency to another of the cells for use as one of the dynamic channels.

In an aspect of the invention, allocating the first respective set of static channels includes determining the number of the static channels such that the probability for all the static channels to be in use is equal at least to the threshold probability, while if a further static channel is added to the first respective set, the probability for all the static channels to be in use is less than the threshold probability. Typically, the predetermined threshold probability is approximately equal to 0.5.

In a disclosed embodiment, allocating the first respective set of static channels includes allocating a given static channel to two or more of the cells, finding a measure of interference between the two or more of the cells in the network, and removing the given static channel from the first respective set of at least one of the two or more of the cells if the measure of interference is not less than a predetermined interference threshold. Typically, finding the measure of interference includes determining elements of an impact matrix. Additionally or alternatively, removing the given static channel includes finding a vertex cover of a graph having nodes representing the cells and edges representing the interference, and choosing the at least one of the two or more of the cells based on the vertex cover.

In another aspect of the invention, the respective number of the channels in the first respective set is a first respective number, and the probability for all the static channels in the first respective set to be in use simultaneously is a first probability, and allocating the second respective set includes determining, based on the estimate of the traffic density, a second respective number of the cells to include in the second respective set for each of the cells so that a second probability that a call to one of the mobile units is blocked due to unavailability of the dynamic channels is no greater than a predetermined blockage probability. In a disclosed embodiment, determining the second respective number includes finding a measure of interference between the cells in the network, and computing the second probability based on the measure of interference and the likelihood of transmission by at least one other cell in the network on one of the frequencies that is allocated for use as one of the dynamic channels.

Typically, allocating the second respective set includes selecting the dynamic channels to allocate to each of the cells so as to increase a likelihood of finding one of the dynamic channels that is substantially free of interference when required for communicating with one of the mobile units.

Additionally or alternatively, allocating the second respective set includes allocating respective individual sets of the dynamic channels to the cells, arranging the cells in multiple groups, and merging the individual sets allocated to the cells in each group among the multiple groups so as to provide a merged set of the dynamic channels for use by all the cells in the group.

There is also provided, in accordance with an embodiment of the present invention, apparatus for channel allocation in a mobile communication network that includes a plurality of cells, the apparatus including a computer, which is adapted to allocate to each of the cells a first respective set of static channels for use in communicating with mobile units, the first respective set including a respective number of the channels that is chosen, based on an estimate of respective traffic density in each of the cells, so that a probability for all the static channels in the first respective set to be in use simultaneously for communicating with the mobile units is no less than a predetermined threshold probability, the computer being further adapted to allocate to each of the plurality of the cells, depending on the static channels allocated to the cells, a second respective set of dynamic channels.

There is additionally provided, in accordance with an embodiment of the present invention, a computer software product for performing channel allocation in a mobile communication network that includes a plurality of cells, the product including a computer-readable medium in which program instructions are stored, which instructions, when read by a computer, cause the computer to allocate to each of the cells a first respective set of static channels for use in communicating with mobile units, the first respective set including a respective number of the channels that is chosen, based on an estimate of respective traffic density in each of the cells, so that a probability for all the static channels in the first respective set to be in use simultaneously for communicating with the mobile units is no less than a predetermined threshold probability, the instructions further causing the computer to allocate to each of the plurality of the cells, depending on the static channels allocated to the cells, a second respective set of dynamic channels.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a hybrid cellular communication network, in accordance with an embodiment of the present invention;

FIG. 2 is a flow chart that schematically illustrates a method for assigning frequency channels to calls in a hybrid cellular network, in accordance with an embodiment of the present invention;

FIG. 3 is a flow chart that schematically illustrates a method for allocating static and dynamic frequency channels among the cells in a hybrid cellular network, in accordance with an embodiment of the present invention;

FIG. 4 is a graph representing interference among cells in a cellular network, illustrating a method for allocating frequency channels among the cells, in accordance with an embodiment of the present invention; and

FIG. 5 is a flow chart that schematically shows details of a method for allocating dynamic frequency channels, in accordance with an embodiment of the present invention.

### DETAILED DESCRIPTION OF EMBODIMENTS

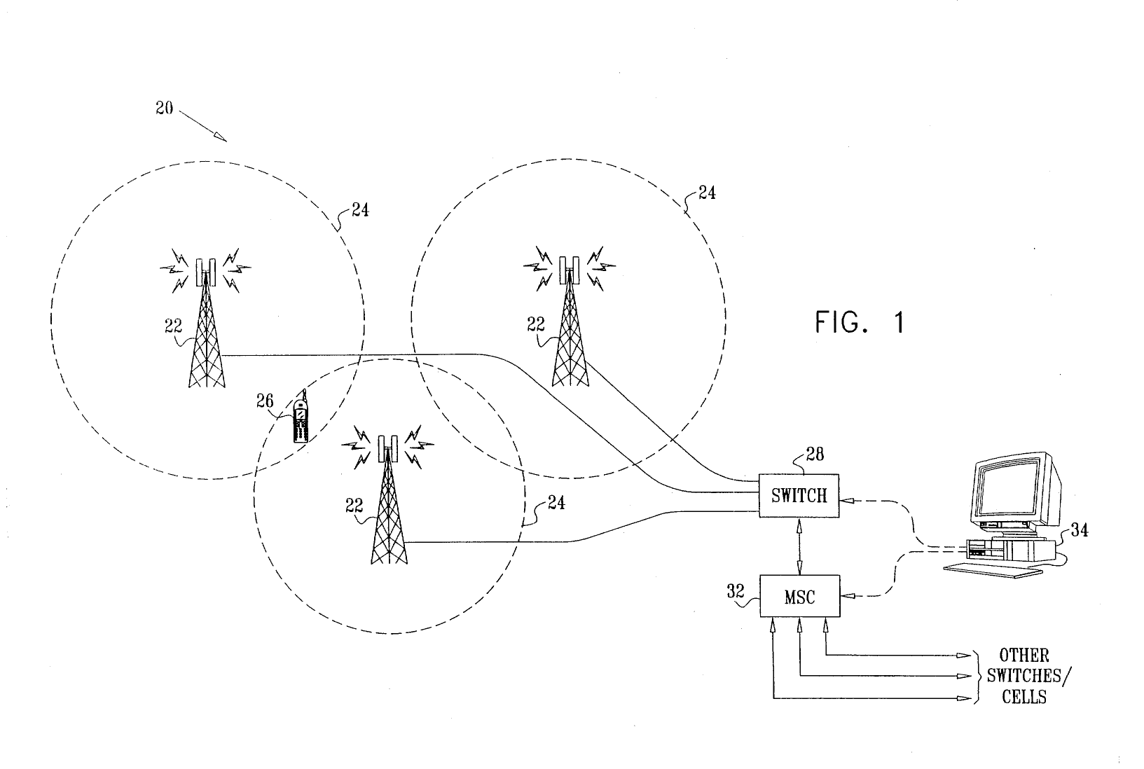

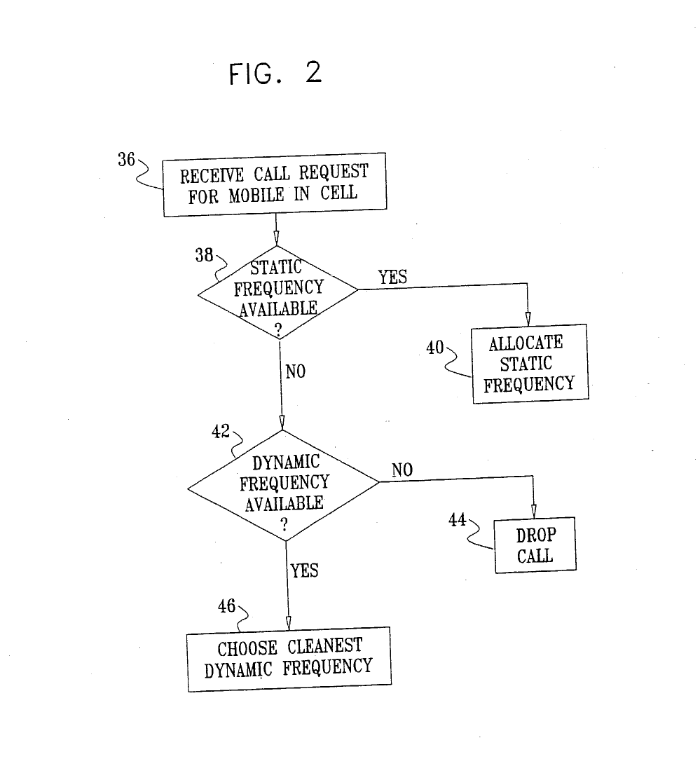

FIG. 1 is a schematic, pictorial view of a hybrid cellular network 20, in accordance with an embodiment of the present invention. A service region of the network is divided into overlapping cells 24, served by respective antennas 22, which communicate with mobile units 26 within their respective cell service areas. Each antenna has a respective transceiver (not shown) which typically includes multiple transmitter cards, operating on different frequencies. Some of the transmitter cards are set to operate at fixed, static frequencies, while others are configured for dynamic frequency operation. Handling of calls to and from mobile units 26 by the static- and dynamic-frequency transmitters is described below with reference to FIG. 2.

The transceivers of antennas 22 are connected, typically via high-speed land lines, to a switch 28, such as an Executive Cellular Processor (ECP) switch. In some networks, as described below, switch 28 holds lists of channels that are available for dynamic operation, and the dynamic-frequency transmitter cards select their frequencies from these lists. Although for the sake of simplicity, only a single switch 28 is shown in FIG. 1, network 20 typically comprises multiple switches of this sort. Communication traffic in cellular network 20 is controlled and routed among switches 28 and antennas 22 by a mobile switching center (MSC) 36, as is known in the art.

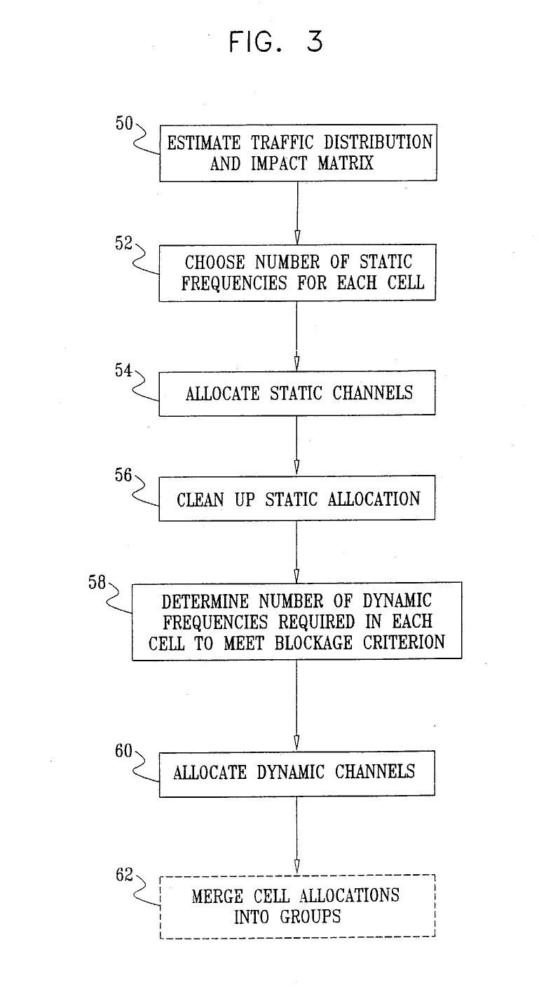

A computer 34 determines how static and dynamic frequencies are to be allocated among cells 24. For this purpose, the computer typically receives information regarding signal propagation and mutual interference among antennas 22 in network 20, as well as the estimated distribution of communication traffic between the antennas and mobile units 26 in different cells of the network. The methods by which computer 37 performs its frequency allocation functions are described in detail hereinbelow with reference to FIG. 3. The computer performs these functions under the control of software supplied for this purpose. The software may be conveyed to the computer in electronic form, over a network, for example, or it may be furnished on tangible media, such as CD-ROM.

FIG. 2 is a flow chart that schematically illustrates a method for assigning frequency channels to calls in hybrid network 20, in accordance with an embodiment of the present invention. The method is initiated when a given cell 24 receives a request to initiate a call to or from mobile unit 26 within its service area, at a call initiation step 36. The cell has a set of static frequencies that have been allocated to it for use in handling the call, as well as a set of dynamic frequencies that are available if all the static frequency channels are in use. Thus, upon receiving the call request, the cell checks whether it has a static frequency channel available, at a static channel checking step 38. If so, the cell simply assigns one of its static channels for handling the call, at a static assignment step 40. Up to this point, the operation of cells 24 in network 20 is not substantially different from the operation of a conventional cellular network, in which all channel assignments are static.

If cell 24 has no static frequencies available to handle the call, however, it checks its list of dynamic frequencies, at a dynamic channel checking step 42. If there are no available dynamic frequencies, either, the requested call is blocked, at a call dropping step 44. The static and dynamic channels in the network are preferably allocated, as described below, so that no more than a small percentage (typically 1-2%) of calls are blocked in this manner. Assuming the dynamic frequencies have not been exhausted, however, cell 24 chooses the cleanest available dynamic frequency to handle the call, at a frequency selection step 46. The allocation and use of dynamic frequencies in this manner reduces the likelihood of call blockage, as well as enhancing call quality.

FIG. 3 is a flow chart that schematically illustrates a method used by computer 34 in determining the allocation of static and dynamic frequency channels among cells 24, in accordance with an embodiment of the present invention. The allocation is based on an estimate of communication traffic distribution in the service region of network 20, which is provided at a network assessment step 50. The traffic estimates may be derived from a priori estimation or from actual measurements of calls served by the different cells in the network. Exemplary methods for estimating traffic distribution are described, for example, in U.S. patent application Ser. No. 10/214,852, entitled, “Estimating Traffic Distribution in a Mobile Communication Network,” filed Aug. 7, 2002, which is assigned to the assignee of the present patent application, and whose disclosure is incorporated herein by reference.

At step 50, computer 34 also receives or determines an estimate of the potential interference between different cells. This interference may be conveniently represented using an impact matrix, as described in the above-mentioned U.S. Pat. No. 6,487,414. Briefly, each element of the impact matrix IM represents the interference between two cells i and j in network 20, such that:

IM_{i;j}=Pr[losing a time-slot in cell i|reuse between i and j] (1)

In other words, IM_{i;j} is the probability of losing a time-slot of transmitted data in cell i due to interference from cell j, in the event that i and j are transmitting simultaneously on the same frequency. The matrix IM is not necessarily symmetrical. The impact matrix elements are calculated based on readily-available network data, such as switch statistics, drive test measurements and signal strength predictions. An exemplary method for processing drive test results in order to estimate signal strengths due to different cells is described in another U.S. patent application entitled, “Classification of Cellular Network Drive Test Results,” filed Mar. 18, 2003, which is assigned to the assignee of the present patent application and whose disclosure is incorporated herein by reference.

Based on the network traffic distribution, computer 34 determines the number of static channels to be allocated to each cell, at a static estimation step 52. Allocating a static channel to a cell creates constraints on overall frequency allocation, as a static channel should be clean (free of interference) with high probability. Therefore, if a static channel is allocated to a cell, it cannot be allocated to the neighboring cells. In other words, allocating a static channel to a cell improves the performance of that cell, but potentially decreases the performance of its neighbors if there are not enough clean channels left to be allocated to the neighbors. Therefore, a static channel should typically be allocated to a cell only if it is expected that the static channel will be used often.

To implement this principle, computer 34 uses a threshold probability of channel use in determining the number of static channels to allocate to each cell. The inventors have found a threshold of 50% to give good results, but alternatively, a higher or lower threshold may be set, or another measure of the likelihood of channel exploitation may be used instead. In the present example, with a 50% probability threshold, each cell c is allocated dc static frequencies, such that the probability that the cell uses all d_{c} frequencies is at least 0.5, while the probability that it uses d_{c}+1 frequencies is less than 0.5. To determine d_{c} for each cell, computer 34 calculates the probability p(m,C,T) that m transmitters out of T total transmitters are in cell c are used, given an average traffic level C. The probability may be calculated, for example, using the Erlang-B model, as is known in the art:

$$p ( m , C , T ) = \frac{{p}_{0} {C}^{m}}{m !} , wherein {p}_{0} = {( {\sum }_{j = 0}^{T} \frac{{C}^{j}}{j !} )}^{- 1} \qquad ( 2 )$$

Thus, to perform step 52, computer 34 finds the smallest m* for which p(m*,C,m*)>0.5.

After calculating d_{c} for all of cells 24, computer 34 decides which specific static frequencies to allocate to each cell, at a static allocation step 54. Substantially any frequency allocation algorithm known in the art may be used for this purpose. For example, a genetic algorithm may be used, as described by Michalewicz in Genetic Algorithms+Data Structures=Evolution Programs (Springer, Berlin, 1996), or by Goldberg in The Design of Innovation: Lessons from and for Competent Genetic Algorithms (Kluwer, Boston, 2002). Both of these publications are incorporated herein by reference. Typically, the frequency allocation algorithm uses a cost function, based on the impact matrix or other factors, in order to choose an allocation that minimizes the likelihood that two cells transmitting on the same frequency might interfere one another. The algorithm attempts to find frequency allocations that do not result in any impact that is greater than a given threshold, typically 1%, meaning that even when static frequencies are used simultaneously by different cells, the probability of a dropped call due to interference is at most 0.01. Since d_{c} is much smaller than the number of frequencies that are needed in order to support all the traffic in each cell, the problem of allocating static frequencies in the hybrid network is typically easy to solve, by comparison with conventional networks in which all frequencies are “static frequencies.”

It is still possible that when the frequency allocation algorithm of step 54 finishes running, there will be some pairs of cells that share one or more static frequencies with a high cost of reuse, i.e., with a high impact between the cells. Computer 34 checks for such violations of the interference threshold, and removes static frequencies from the allocations as necessary in order to “clean up” the violations, at a static clean-up step 56. The purpose of this step is to ensure that all the static frequencies are relatively free of interference, while removing as few static allocations as possible in order to satisfy this condition.

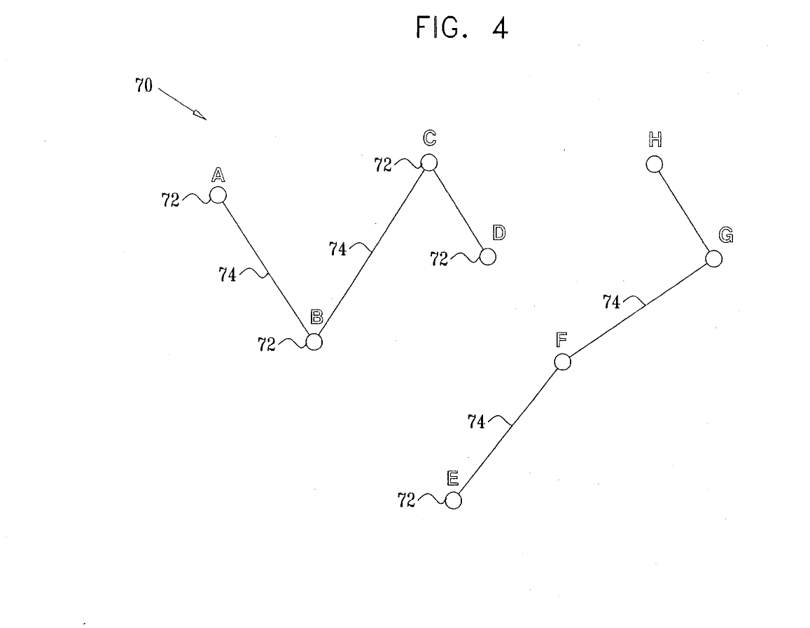

FIG. 4 is a graph 70 that schematically models interference among cells 24 and illustrates a method used by computer 34 in carrying out step 56, in accordance with an embodiment of the present invention. Cells 24 in network 20 are represented by nodes 72, while edges 74 represent interfering frequencies. To build graph 70, a threshold t is chosen such that any impact between cells larger than t must be removed. Each allocation of a frequency f to two cells x and y such that either IM_{x,y}>t or IM_{y,x}>t is represented by an edge connecting vertices (x;f) and (y;f) in the graph. If cell x or y interferes with other cells on frequency f, additional edges connecting to the corresponding nodes are added to the graph, as shown in the figure. A similar graph is constructed for each different static frequency on which interference over threshold t is found to exist between any pair of cells.

The problem of finding the smallest number of frequency allocations that should be removed at step 56 is equivalent to the problem of finding a minimal vertex-cover of graph 70. (The minimal vertex cover is the minimal set of edges required so that each node is an endpoint of at least one edge. In the simple case of FIG. 4, removing edges BC and FG will leave a minimal vertex cover.) Since a relatively small number of static frequencies is allocated to each cell at step 54, the number of impact violations is also generally small. In other words, graph 70 is typically sparse, making the problem of finding a vertex cover relatively simple. Table I below presents an exemplary method for solving the problem on a graph G with nodes u and v, based on identifying leaves in the graph (i.e., nodes that are connected by only a single edge):

TABLE I
FINDING A VERTEX COVER

VC= { }
while there are edges in G

if G has a leaf, v

add v's neighbor to VC
remove v's neighbor and all edges adjacent to

it

else

pick an edge (u,v)
add u and v to VC
remove any edge adjacent either to u or v

end

end
return VC

Frequency f is then removed from the static allocation of all the cells corresponding to nodes in set VC.

It can be shown that the method of Table I will, in the worst case, result in removal of twice the minimum number of frequency allocations needed in order to meet the impact threshold criterion on all cells. Exact methods for finding the vertex cover of a graph are also known in the art, but are generally computationally heavier than the simple method shown here. Because of the sparseness of graph 70, however, it may still be feasible to use an exact method to find the vertex cover and complete the frequency clean-up of step 56.

Returning now to FIG. 3, after completing allocation and clean-up of the static frequency channels, computer 34 proceeds to determine the number of dynamic channels to be allocated to each cell 24, at a dynamic estimation step 58. Unlike static channels, the dynamic channels are not guaranteed to be clean. Therefore, computer 34 attempts to create a pool of dynamic channels for each cell that is larger than the traffic that the cell is expected to support. Clearly, if the pool is too small, the cell may not find any clean frequency at step 42 (FIG. 2). On the other hand, allocating too many frequencies can cause excessive interference with the neighboring cells. To find the proper balance between these conflicting requirements, computer 34 uses a blockage threshold, for example, 2%. In other words, a given allocation of dynamic frequencies is considered sufficient if the set of static and dynamic channels assigned to a cell is adequate to serve all of the traffic in that cell with a probability of at least 0.98, i.e., with a likelihood of at most 2% that a call will be blocked because no frequency is available.

In order to determine the probability b of a blockage occurring in a given cell, we begin by computing the probability q_{s,f} of other cells s using frequency f as a static frequency. Since each static frequency is allocated to a particular transmitter, the probability q_{s,f} is equal to the probability of the particular transmitter being active. Assuming that when a new call arrives in cell s (step 36 in FIG. 2), it is served by the next available transmitter chosen at random, q_{s,f} can be expressed in terms of the function p(m,C,T) defined by equation (2), wherein T is the number of static-frequency transmitters:

$${q}_{s , f} = {\sum }_{m = 1}^{T} p ( m , C , T ) \frac{m}{T} \qquad ( 3 )$$

Using this definition, together with the definition of the impact matrix in equation (1), the probability q_{f} that cell c will be able to use frequency f as a dynamic frequency without interference from static-frequency transmission by other cells is given by:

$${q}_{f} = {\prod }_{s ∈ N ( f )}^{} ( 1 - {q}_{s , f} \cdot {IM}_{s , c} ) \qquad ( 4 )$$

Here N(f) is the set of cells having f as one of their static channels. Equation (4) neglects the probability of interference from other cells using f as a dynamic channel, so that the actual probability that cell c will be able to use f without interference is smaller than q_{f}. In practice, however, the probability of other cells using f as a dynamic channel is generally much smaller than the probability of their using f as a static channel, so that equation (4) is a good estimate of the actual probability that f will be interference-free. If a more accurate estimate of the probability is desired, the computation may be repeated recursively, taking the dynamic channels into account, as well.

If cell c is allocated dynamic frequencies 1 through k, the expected number of clean dynamic channels available to the cell is estimated to be μ

$$μ = {\sum }_{i = 1}^{k} {q}_{i} .$$

This definition can be used, together with principles of probability theory, to derive an upper bound on the probability lₜ that cell c has less than t dynamic channels available to it:

$${l}_{t} \leq min \{ {ⅇ}^{- 2 {( μ - t )}^{2} / k} , {σ}^{2} / {( μ - t )}^{2} \} \qquad ( 5 )$$

wherein

$${σ}^{2} = {\sum }_{i = 1}^{k} {q}_{i}^{2} .$$

The probability b of a call blockage in cell c, with T static-frequency transmitters and D dynamic-frequency transmitters is then bounded by:

$$b \leq {\sum }_{t = 1}^{D} {\sum }_{i = t - 1}^{D} p ( T + i , T + D , C ) \cdot {l}_{t} \qquad ( 6 )$$

Thus, at step 58, computer 34 sets b to the desired threshold value, such as 0.02, and then finds the number of dynamic transmitters D that will satisfy formula (6), taking given values of T and C for each cell.

Computer 34 uses the result of step 58 in allocating dynamic channels to all of cells 24, at a dynamic allocation step 60. Typically, the same type of allocation algorithm is used here as in step 54. The number of dynamic transmitters D determined for each cell at step 58 is initially used as a lower bound on the number of dynamic channels to be assigned to each cell. After running the frequency allocation algorithm, the computer computes the blockage probabilities b using formula (6). For each cell for which b still exceeds the threshold value, the number of dynamic channels to be allocated is increased, typically by some constant fraction, and the frequency allocation algorithm is run again. This process continues iteratively until the blockage criterion is satisfied for all cells.

In some cases, after completing the dynamic frequency allocations at step 60, computer 34 merges the allocations into groups, at a merging step 62. The requirement to carry out step 62 typically stems from hardware limitations that are present in some cellular networks. For example, the lists of dynamic channels to be used by each cell may be held not at antennas 22, but rather in switch 28, and the switch may allow only a limited number of different lists. In this case, each cell must use the dynamic channels on one of the lists held by switch 28, and the number of these lists may be substantially smaller than the number of cells in network 20.

To carry out step 62 when necessary, computer 34 typically begins by finding pairs of cells 24, and then joins the pairs into larger groups, until the number of groups is no greater than the maximum number of dynamic channel lists. The sets of dynamic channels that are allocated to the cells in each group are then merged, and the merged set is shared by all the cells in the group. The process can be visualized in terms of a graph, in which each cell is initially represented by a vertex. A cost function (or “penalty”) is computed for each possible merger of two vertices, depending on the noise that may result from adding a frequency to a group and the possibility of increased blockage when a frequency is removed. The pair of vertices with the lowest associated cost are merged into a single vertex, and the cost functions are then recalculated. This process is repeated until the number of remaining vertices is equal to the number of permitted dynamic channel lists. Each remaining vertex represents one of the groups of cells that have been created by the merger process, and all the cells in the group share the same, merged dynamic channel list.

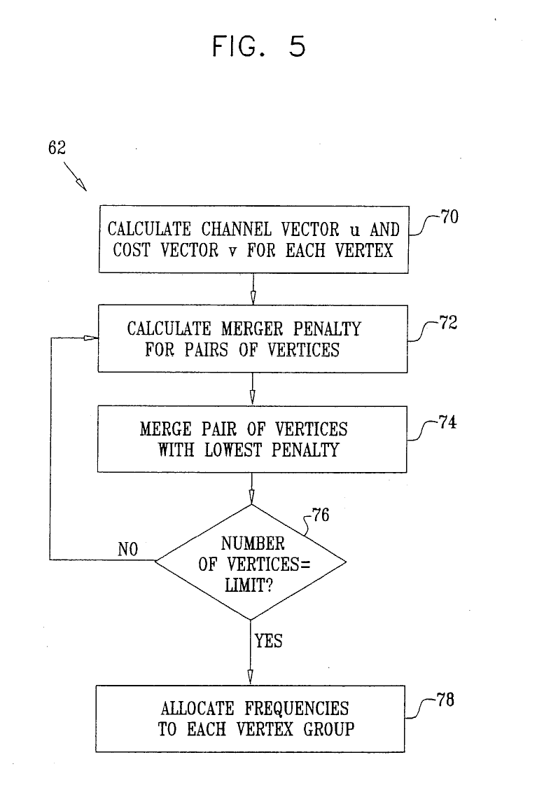

FIG. 5 is a flow chart that schematically shows details of the method of step 62, in accordance with an embodiment of the present invention. The method is based on calculating two vectors, u and v, for each cell or group of cells, at a vector calculation step 70. Both of these vectors have a number of entries that is equal to the number of available dynamic channels. The entries of u represent the frequencies that are allocated to each cell or group of cells in the merge process. These entries are initially equal to 1 for all channels allocated to a given cell, and 0 for all others.

The entries of v represent the cost of adding each new frequency to the set of frequencies currently allocated to the given cell or group of cells. These entries are initially set to 0 for the static frequencies of the cell and of its neighboring cells, as well as for the dynamic frequencies in the set that is allocated to the cell. The remaining entries in v may simply be set to 1 initially, or they may be computed to express potential interference between cells, typically based on the impact matrix. For example, entry v_{k,i} for frequency i in cell k may be given by:

$${v}_{k , i} = a {\sum }_{j ∈ {U}_{i}}^{} {IM}_{k , j} + ( 1 - a ) {\sum }_{j ∉ {U}_{i}}^{} {IM}_{k , j} + c \qquad ( 7 )$$

wherein Uᵢ is the set of cells using frequency i, and a and c are user-defined constants. Typically, a=0.8, and c=1. Alternatively, the elements of v may be given by

$${v}_{k , i} = {\sum }_{j ∈ {U}_{i}}^{} {IM}_{k , j} \frac{{C}_{j}}{{D}_{j}} ,$$

wherein Cⱼ represents the traffic in cell j, and Dⱼ is the number of frequencies allocated to cell j. Further alternatively, other schemes may be used to initialize the vector v, depending on other impact, traffic, frequency planning and other factors that may affect service characteristics in network 20.

At each iteration through the method of FIG. 5, a penalty factor P is computed for each pair of vertices remaining in the graph (wherein each vertex represents a cell or group of cells, as noted above), at a penalty computation step 72. To account for both the costs of both adding and removing frequencies, a penalty balance vector t is defined as follows for each pair of vertices:

t←α(u₁+u₂)−(1−α)(v₁+v₂) (8)

Here u₁, u₂, v₁ and v₂ are the respective u- and v-vectors for vertices 1 and 2, respectively, and α is a user-defined factor, used to balance the relative weights of channel removal and channel addition penalties. Typically, α=0.7. The penalty factor for each pair of vertices 1 and 2 is then given by:

$$P ← ( 1 - α ) {\sum }_{i : {t}_{i} \geq 0}^{} ( {v}_{1 , i} + {v}_{2 , i} ) + α {\sum }_{i : {t}_{i} \geq 0}^{} ( {u}_{1 , i} + {u}_{2 , i} ) - ( {W}_{1} + {W}_{2} ) \qquad ( 9 )$$

In this equation, the index i again refers to frequency channels. W₁ and W₂ are accrued penalty factors that were computed for vertices 1 and 2 on earlier iterations through step 72. Initially, W=0.

Computer 34 selects the pair of vertices that have the lowest penalty factor P, at a merger step 74. These two vertices are merged into a single new vertex, meaning that the cells or groups of cells corresponding to each of the original vertices are merged into a single group represented by the new vertex. New values of the u and v vectors, as well as a new accrued penalty value, are computed for the new vertex: u←u₁+u₂, v←v₁+v₂, and W←W+P. Computer 34 checks the number of vertices remaining after the merge, at a limit checking step 76. If the number of vertices is still greater than the permitted number of dynamic channel lists, the computer returns to iterate through steps 72 and 74, until the number of vertices is reduced to the permitted limit.

Once the required number of vertices is reached, computer 34 regroups the dynamic frequencies, which were originally allocated at step 60, to accord with the merged groups of cells corresponding to the remaining vertices, at a channel reallocation step 78. For this purpose, the computer uses the vector t that was calculated for each vertex in the final graph. For each group of cells, those frequencies i for which tᵢ>0 at the corresponding vertex are included in the set of dynamic frequencies that are allocated to the group, while frequencies for which tᵢ<0 are omitted from the group (The reason for this choice is that the blockage penalty for omitting frequencies with positive t-vector values is considered to outweigh the interference penalty for using these frequencies, and vice versa with regard to negative t-vector values.) Entries for which tᵢ=0 can be included in or omitted from the dynamic frequency set arbitrarily, for example, by including these frequencies at random with probability 0.5.

Although certain specific algorithms are described hereinabove for allocating static and dynamic frequency channels in a hybrid network, alternative algorithms implementing the principles of the present invention will be apparent to those skilled in the art and are considered to be within the scope of the present invention. More generally, although embodiments of the present invention are described above with reference to certain specific types and configurations of hybrid cellular networks, the principles of the present invention may similarly be applied to solve problems of frequency allocation in mobile communication networks of other types.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for channel allocation in a mobile communication network, comprising:
providing an estimate of respective traffic density in each of a plurality of cells in the network;
allocating to each of the plurality of the cells a first respective set of static channels for use in communicating with mobile units, the first respective set comprising a respective number of the channels that is chosen based on the estimate of the traffic density so that a probability for all the static channels in the first respective set to be in use simultaneously for communicating with the mobile units is no less than a predetermined threshold probability; and
allocating to each of the plurality of the cells, depending on the static channels allocated to the cells, a second respective set of dynamic channels.

2. The method according to claim 1, wherein each of the cells uses the static channels to communicate with the mobile units as long as at least one of the static channels in the first respective set is available, and uses the dynamic channels otherwise.

3. The method according to claim 1, wherein allocating the first respective set comprises allocating a given frequency to one of the cells for use as one of the static channels, and wherein allocating the second respective set comprises allocating the given frequency to another of the cells for use as one of the dynamic channels.

4. The method according to claim 1, wherein allocating the first respective set of static channels comprises determining the number of the static channels such that the probability for all the static channels to be in use is equal at least to the threshold probability, while if a further static channel is added to the first respective set, the probability for all the static channels to be in use is less than the threshold probability.

5. The method according to claim 4, wherein the predetermined threshold probability is approximately equal to 0.5.

6. The method according to claim 1, wherein allocating the first respective set of static channels comprises:
allocating a given static channel to two or more of the cells;
finding a measure of interference between the two or more of the cells in the network; and
removing the given static channel from the first respective set of at least one of the two or more of the cells if the measure of interference is not less than a predetermined interference threshold.

7. The method according to claim 6, wherein finding the measure of interference comprises determining elements of an impact matrix.

8. The method according to claim 6, wherein removing the given static channel comprises finding a vertex cover of a graph having nodes representing the cells and edges representing the interference, and choosing the at least one of the two or more of the cells based on the vertex cover.

9. The method according to claim 1, wherein the respective number of the channels in the first respective set is a first respective number, and the probability for all the static channels in the first respective set to be in use simultaneously is a first probability, and
wherein allocating the second respective set comprises determining, based on the estimate of the traffic density, a second respective number of the cells to include in the second respective set for each of the cells so that a second probability that a call to one of the mobile units is blocked due to unavailability of the dynamic channels is no greater than a predetermined blockage probability.

10. The method according to claim 9, wherein determining the second respective number comprises finding a measure of interference between the cells in the network, and computing the second probability based on the measure of interference and the likelihood of transmission by at least one other cell in the network on one of the frequencies that is allocated for use as one of the dynamic channels.

11. The method according to claim 1, wherein allocating the second respective set comprises selecting the dynamic channels to allocate to each of the cells so as to increase a likelihood of finding one of the dynamic channels that is substantially free of interference when required for communicating with one of the mobile units.

12. The method according to claim 1, wherein allocating the second respective set comprises allocating respective individual sets of the dynamic channels to the cells, arranging the cells in multiple groups, and merging the individual sets allocated to the cells in each group among the multiple groups so as to provide a merged set of the dynamic channels for use by all the cells in the group.

13. Apparatus for channel allocation in a mobile communication network that includes a plurality of cells, the apparatus comprising a computer, which is adapted to allocate to each of the cells a first respective set of static channels for use in communicating with mobile units, the first respective set comprising a respective number of the channels that is chosen, based on an estimate of respective traffic density in each of the cells, so that a probability for all the static channels in the first respective set to be in use simultaneously for communicating with the mobile units is no less than a predetermined threshold probability, the computer being further adapted to allocate to each of the plurality of the cells, depending on the static channels allocated to the cells, a second respective set of dynamic channels.

14. The apparatus according to claim 13, wherein each of the cells uses the static channels to communicate with the mobile units as long as at least one of the static channels in the first respective set is available, and uses the dynamic channels otherwise.

15. The apparatus according to claim 13, wherein the computer is adapted to allocate a given frequency to one of the cells for use as one of the static channels, and to allocate the given frequency to another of the cells for use as one of the dynamic channels.

16. The apparatus according to claim 13, wherein the computer is adapted to determine the number of the static channels to allocate to each of the cells so that the probability for all the static channels to be in use is equal at least to the threshold probability, while if a further static channel is added to the first respective set, the probability for all the static channels to be in use is less than the threshold probability.

17. The apparatus according to claim 16, wherein the predetermined threshold probability is approximately equal to 0.5.

18. The apparatus according to claim 13, wherein after allocating a given static channel to two or more of the cells, the computer is adapted to find a measure of interference between the two or more of the cells in the network and to remove the given static channel from the first respective set of at least one of the two or more of the cells if the measure of interference is not less than a predetermined interference threshold.

19. The apparatus according to claim 18, wherein the measure of interference is determined based on elements of an impact matrix.

20. The apparatus according to claim 18, wherein the computer is adapted to find a vertex cover of a graph having nodes representing the cells and edges representing the interference, and to choose the at least one of the two or more of the cells based on the vertex cover.

21. The apparatus according to claim 13, wherein the respective number of the channels in the first respective set is a first respective number, and the probability for all the static channels in the first respective set to be in use simultaneously is a first probability, and
wherein to allocate the second respective set, the computer is adapted to determine, based on the estimate of the traffic density, a second respective number of the cells to include in the second respective set for each of the cells so that a second probability that a call to one of the mobile units is blocked due to unavailability of the dynamic channels is no greater than a predetermined blockage probability.

22. The apparatus according to claim 21, wherein the computer is adapted to find a measure of interference between the cells in the network, and to compute the second probability based on the measure of interference and the likelihood of transmission by at least one other cell in the network on one of the frequencies that is allocated for use as one of the dynamic channels.

23. The apparatus according to claim 13, wherein the computer is adapted to select the dynamic channels to allocate to each of the cells so as to increase a likelihood of finding one of the dynamic channels that is substantially free of interference when required for communicating with one of the mobile units.

24. The apparatus according to claim 13, wherein the computer is adapted to allocate respective individual sets of the dynamic channels to the cells, to arrange the cells in multiple groups, and to merge the individual sets allocated to the cells in each group among the multiple groups so as to provide a merged set of the dynamic channels for use by all the cells in the group.

25. A computer software product for performing channel allocation in a mobile communication network that includes a plurality of cells, the product comprising a computer-readable medium in which program instructions are stored, which instructions, when read by a computer, cause the computer to allocate to each of the cells a first respective set of static channels for use in communicating with mobile units, the first respective set comprising a respective number of the channels that is chosen, based on an estimate of respective traffic density in each of the cells, so that a probability for all the static channels in the first respective set to be in use simultaneously for communicating with the mobile units is no less than a predetermined threshold probability, the instructions further causing the computer to allocate to each of the plurality of the cells, depending on the static channels allocated to the cells, a second respective set of dynamic channels.

26. The product according to claim 25, wherein each of the cells uses the static channels to communicate with the mobile units as long as at least one of the static channels in the first respective set is available, and uses the dynamic channels otherwise.

27. The product according to claim 25, wherein the instructions cause the computer to allocate a given frequency to one of the cells for use as one of the static channels, and to allocate the given frequency to another of the cells for use as one of the dynamic channels.

28. The product according to claim 25, wherein the instructions cause the computer to determine the number of the static channels to allocate to each of the cells so that the probability for all the static channels to be in use is equal at least to the threshold probability, while if a further static channel is added to the first respective set, the probability for all the static channels to be in use is less than the threshold probability.

29. The product according to claim 28, wherein the predetermined threshold probability is approximately equal to 0.5.

30. The product according to claim 25, wherein the instructions cause the computer, after allocating a given static channel to two or more of the cells, to find a measure of interference between the two or more of the cells in the network and to remove the given static channel from the first respective set of at least one of the two or more of the cells if the measure of interference is not less than a predetermined interference threshold.

31. The product according to claim 30, wherein the measure of interference is determined based on elements of an impact matrix.

32. The product according to claim 30, wherein the instructions cause the computer to find a vertex cover of a graph having nodes representing the cells and edges representing the interference, and to choose the at least one of the two or more of the cells based on the vertex cover.

33. The product according to claim 25, wherein the respective number of the channels in the first respective set is a first respective number, and the probability for all the static channels in the first respective set to be in use simultaneously is a first probability, and
wherein to allocate the second respective set, the instructions cause the computer to determine, based on the estimate of the traffic density, a second respective number of the cells to include in the second respective set for each of the cells so that a second probability that a call to one of the mobile units is blocked due to unavailability of the dynamic channels is no greater than a predetermined blockage probability.

34. The product according to claim 33, wherein the instructions cause the computer to find a measure of interference between the cells in the network, and to compute the second probability based on the measure of interference and the likelihood of transmission by at least one other cell in the network on one of the frequencies that is allocated for use as one of the dynamic channels.

35. The product according to claim 25, wherein the instructions cause the computer to select the dynamic channels to allocate to each of the cells so as to increase a likelihood of finding one of the dynamic channels that is substantially free of interference when required for communicating with one of the mobile units.

36. The product according to claim 25, wherein the instructions cause the computer to allocate respective individual sets of the dynamic channels to the cells, to arrange the cells in multiple groups, and to merge the individual sets allocated to the cells in each group among the multiple groups so as to provide a merged set of the dynamic channels for use by all the cells in the group.
